(19) United States
(12) Patent Application Publication
(10) Pub. No.: US 2026/0043293 A1
(43) Pub. Date: Feb. 12, 2026

(54) KIT FOR THE ASSEMBLY OF A MAIN DOOR FOR THE CLOSURE OF A COMPARTMENT, PARTICULARLY OF A GARAGE COMPARTMENT

(71) Applicant: SILVELOX GROUP S.p.A., Castelnuovo (TN) (IT)

(72) Inventor: Stefano CARLIN, Castelnuovo (TN) (IT)

(73) Assignee: SILVELOX GROUP S.p.A., Castelnuovo (TN) (IT)

(21) Appl. No.: 19/102,002

(22) PCT Filed: Aug. 2, 2023
(86) PCT No.: PCT/IB2023/057836

§ 371 Date: Feb. 7, 2025

(30) Foreign Application Priority Data
Aug. 10, 2022 (IT) 102022000017130

(51) Int. Cl. E06B 3/48; E05D 13/00; E05D 15/22; E05D 15/44; E06B 3/70

(52) U.S. Cl. CPC E06B 3/485; E05D 13/145; E05D 15/22; E05D 15/445; E05D 2015/225; E05Y 2201/434; E05Y 2201/684; E05Y 2600/58; E05Y 2800/205; E05Y 2900/106; E05Y 2900/132; E06B 2003/7044

(57) ABSTRACT

A kit for the assembly of a main door comprises at least two fixed uprights and at least one fixed crossbeam, associable with each other to define a fixed frame that can be attached to an access opening of a compartment, wherein the access opening has relevant reference dimensions; at least two movable uprights and a plurality of panels, associable with the movable uprights to define a movable leaf; a movement device/structure/component/element/unit/apparatus, associable between the movable uprights and the fixed frame; where at least one of the fixed uprights, the fixed crossbeam and the movable uprights is made according to respective predefined standard dimensions, which are bigger than the reference dimensions, and comprises at least one related trimmable portion, provided with at least one graduated reference scale adapted to allow the cutting of the trimmable portion depending on the reference dimensions.

### TECHNICAL FIELD

The present invention relates to a kit for the assembly of a main door for the closure of a compartment, particularly of a garage compartment.

### BACKGROUND ART

Main doors intended for the closure of compartments, e.g., garage compartments, are known to consist generally of two fixed uprights and a fixed crossbeam, associated with each other to define a fixed frame which can be attached to an access opening of a compartment, and of at least two movable uprights and a plurality of panels, associated with the movable uprights to define a movable leaf with respect to the fixed frame.

Main doors of known type comprise movement means positioned between the fixed frame and the movable leaf, which are adapted to determine the movement of the latter between a closure configuration and an opening configuration of the compartment.

In detail, the movement means can be of various type and, consequently the main door is classified as an overhead door, sliding door, sectional door, etc.

Frequently, the movement means have lever and counterweight systems which make, therefore, the installation of the main door complex.

Such systems, in fact, require careful positioning of the various components according to the actual size of the main door, that is, the size of the access opening.

For this reason, prior to the production of the components, specialized technicians ensure that the access opening is measured and the necessary measurements are taken to make a specific main door.

Next, the manufacturing company manufactures the various components according to the height and width of the access opening, which are then assembled at a later stage.

This inevitably results in long waiting times.

In fact, the customer, after deciding on the type of main door, has to wait for the contact person for the on-site survey of measurements, the necessary timelines for the production of the components and, finally, the availability of specialized technicians for on-site installation.

In addition to this, it may happen that the measurements taken were not such as to ensure that the main door components fit perfectly to the dimensions of the compartment access opening.

In such a case, it is necessary to intervene during the on-site assembly stages by trying to correct discrepancies, which may jeopardize proper execution of operations, functionality of the main door and satisfaction of the final customer. In the worst case, it is necessary to arrange for the production of new components, further lengthening the delivery and installation timelines of the main door.

### DESCRIPTION OF THE INVENTION

The main aim of the present invention is to devise a kit for the assembly of a main door for the closure of a compartment, particularly of a garage compartment, which makes it possible to free oneself from the need to take accurate measurements prior to the production of the same.

Another object of the present invention is to devise a kit for the assembly of a main door for the closure of a compartment, particularly of a garage compartment, which allows the assembly and installation operations to be carried out quickly and accurately.

Another object of the present invention is to devise a kit for the assembly of a main door for the closure of a compartment, particularly of a garage compartment, which can overcome the aforementioned drawbacks of the prior art within the framework of a simple, rational, easy and effective to use as well as cost-effective solution.

The above objects are achieved by this kit for the assembly of a main door for the closure of a compartment, particularly of a garage compartment, having the characteristics of claim 1.

### BRIEF DESCRIPTION OF THE DRAWINGS

Other characteristics and advantages of the present invention will become more apparent from the description of a preferred, but not exclusive, embodiment of a kit for the assembly of a main door for the closure of a compartment, particularly of a garage compartment, illustrated by way of an indicative, yet non-limiting example, in the accompanying tables of drawings in which:

FIGS. 1 and 2 are axonometric views of the kit according to the invention, from two different angles;

FIGS. 3 and 4 are axonometric views of a main door which can be made with the kit according to the invention, from two different angles;

FIGS. 5 and 6 are axonometric views of a fixed crossbeam according to the invention, from two different angles;

FIGS. 7 and 8 are axonometric views of a trimmable portion of the fixed crossbeam according to the invention, from two different angles;

FIGS. 9 and 10 are axonometric views of a fixed upright according to the invention, from two different angles;

FIGS. 11 and 12 are axonometric views of a trimmable portion of the upright according to the invention, from two different angles;

FIGS. 13 and 14 are axonometric views of a movable upright according to the invention, from two different angles;

FIGS. 15 and 16 are axonometric views of a trimmable portion of the movable upright and of the lateral supporting arm according to the invention, from two different angles;

FIGS. 17 and 18 are axonometric views of the first graduated positioning scale and of the second graduated positioning scale of the movable upright according to the invention.

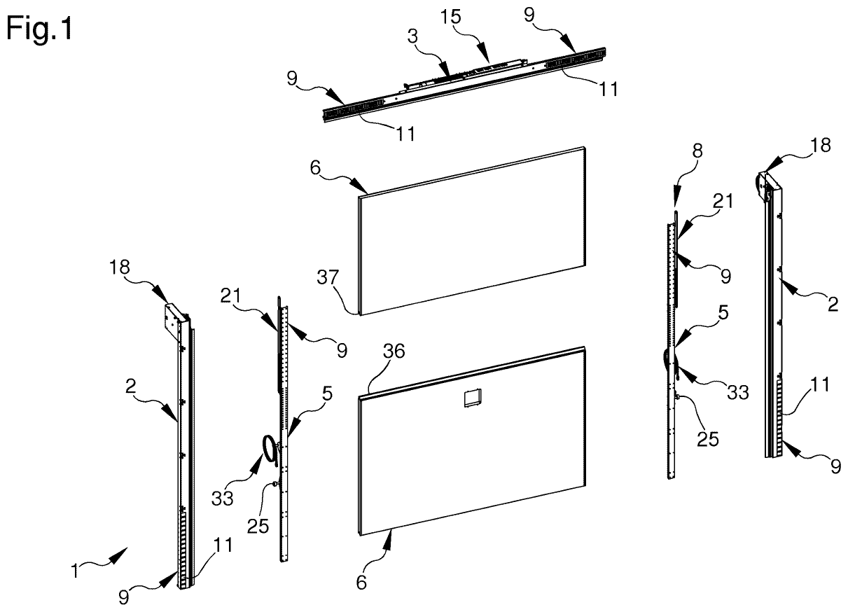

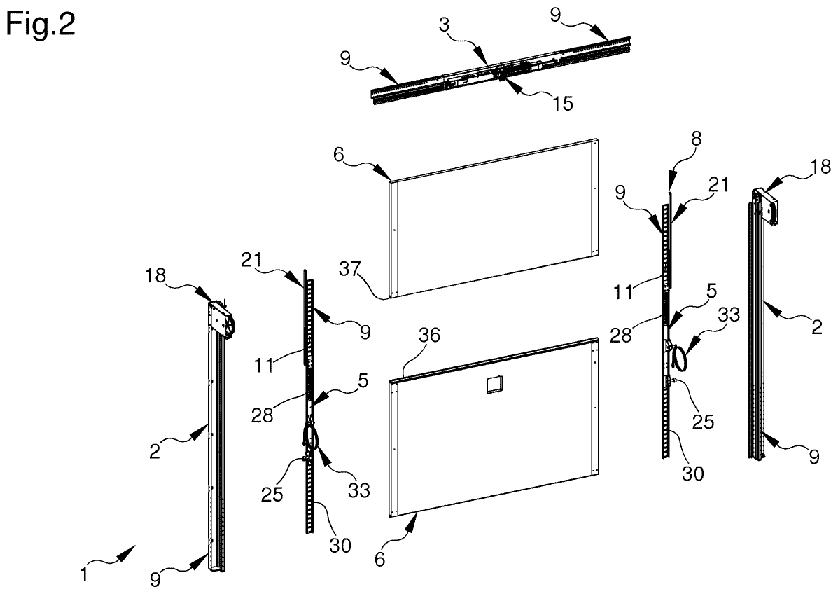

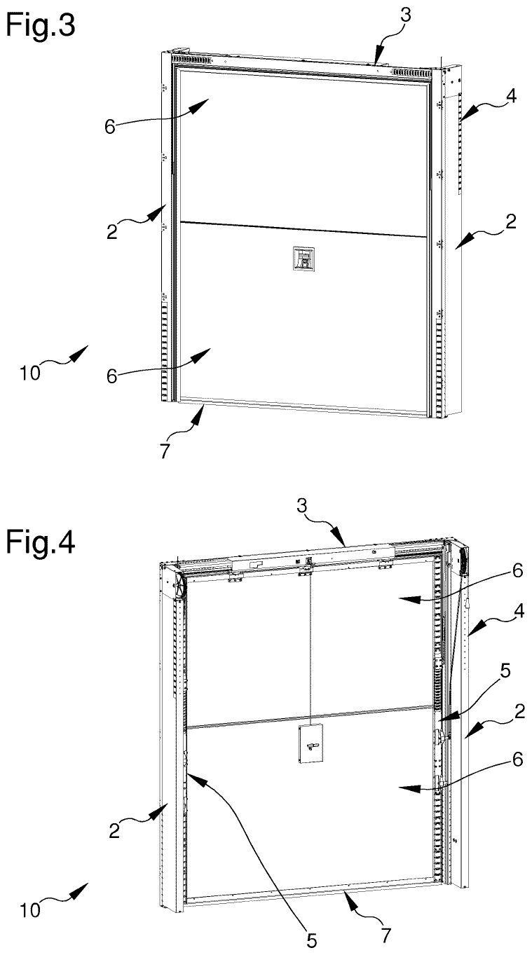

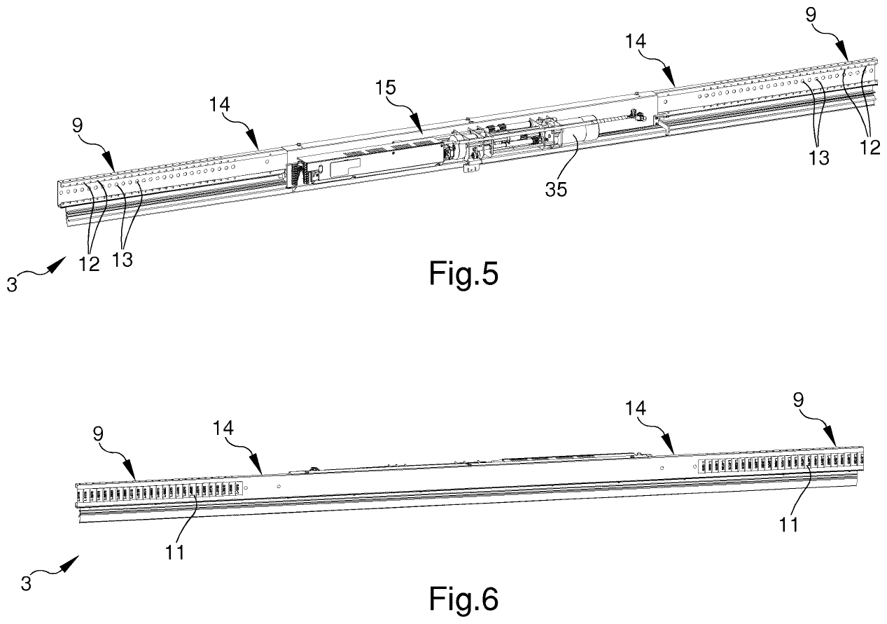

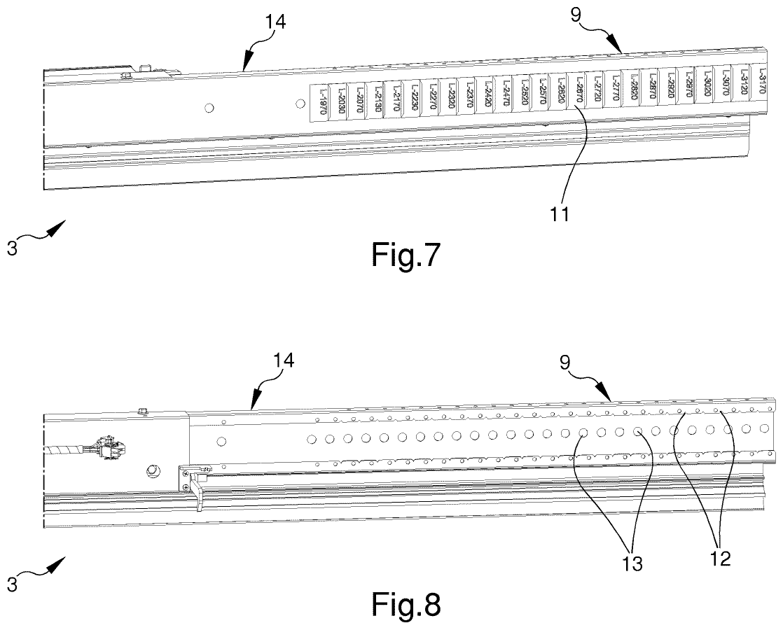

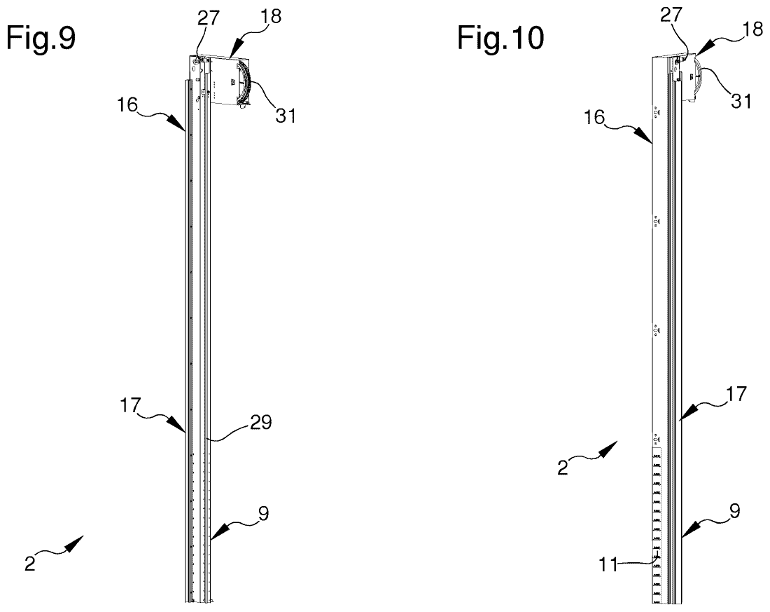

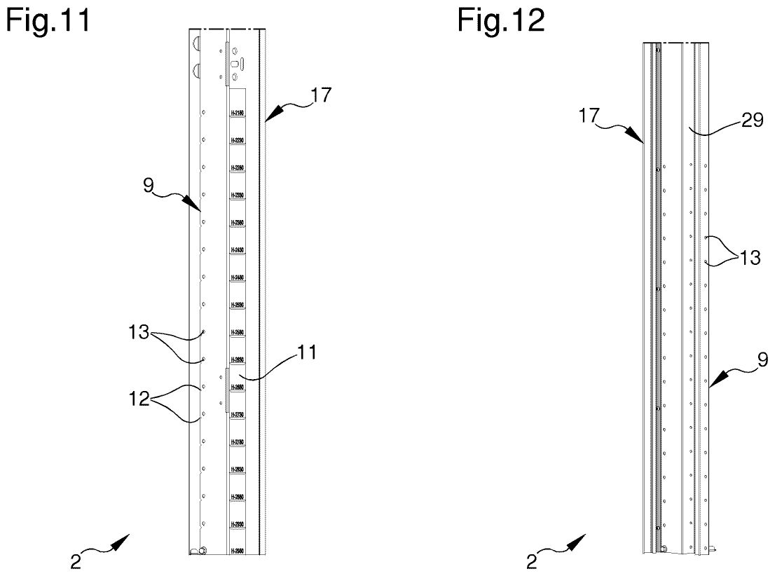

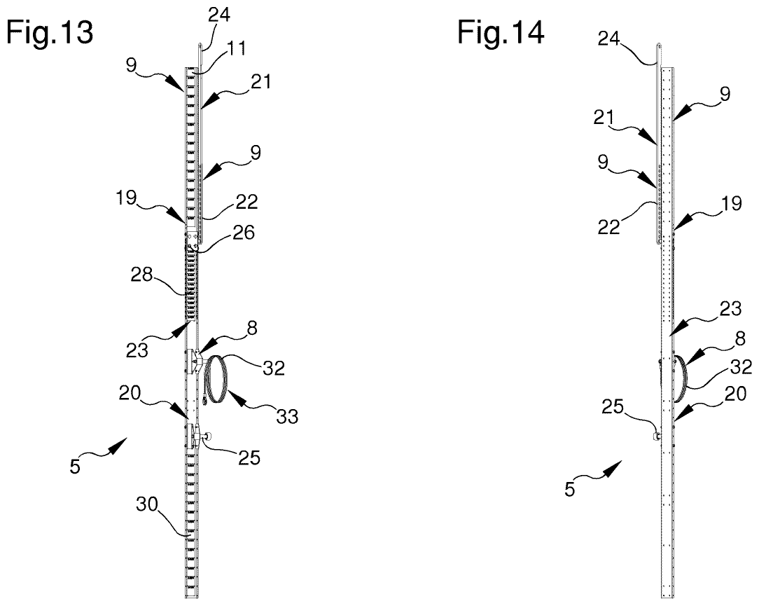

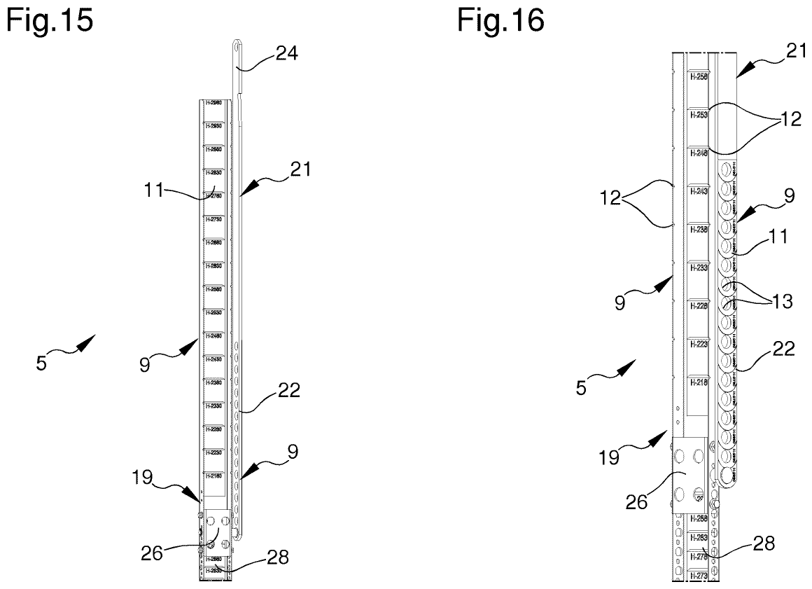

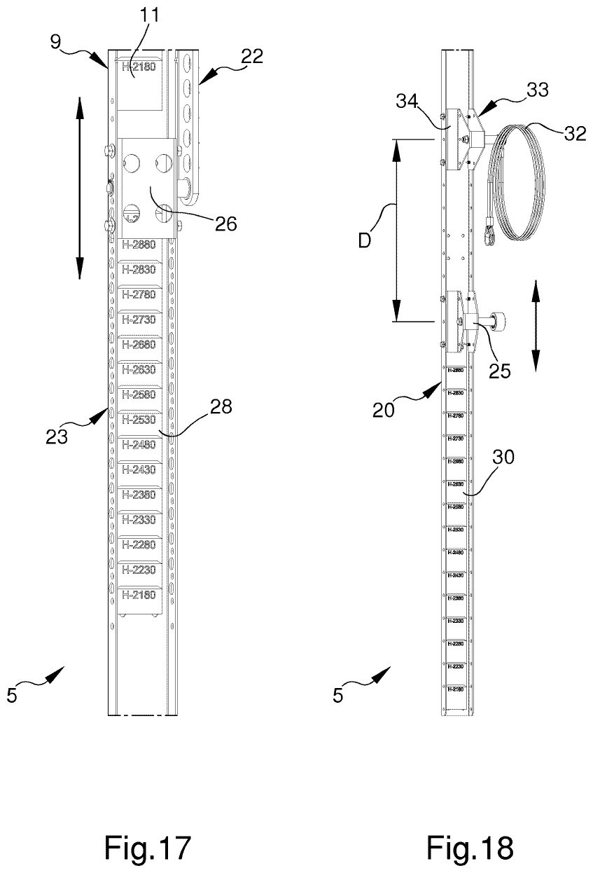

### EMBODIMENTS OF THE INVENTION

With particular reference to these figures, reference numeral 1 globally denotes a kit for the assembly of a main door for the closure of a compartment, particularly of a garage compartment.

The kit 1 comprises at least two fixed uprights 2 and at least one fixed crossbeam 3, associable with each other to define a fixed frame 4 that can be attached to an access opening of a compartment.

Specifically, the term “compartment” refers to a garage compartment, but the possibility that the compartment can be of a different type cannot be ruled out. The access opening has relevant reference dimensions.

In detail, the reference dimensions comprise at least one value of height and one value of width.

In addition, the kit 1 comprises at least two movable uprights 5 and a plurality of panels 6, associable with the movable uprights 5 to define a movable leaf 7. Further embodiments cannot be ruled out wherein the kit 1 also comprises two movable crossbeams, associable with the movable uprights 5 to define a surrounding frame adapted to support the panels 6.

The movable leaf 7 is movable with respect to the frame 4 between a closure configuration, wherein it is arranged to close the access opening, and an opening configuration, wherein it clears the access opening and allows the entry/exit to/from the compartment.

For this purpose, the kit 1 comprises movement means 8, associable between the movable uprights 5 and the frame 4 and adapted to determine, in use, the movement of the movable leaf 7 with respect to the frame itself.

The aforementioned components can be assembled together to form a main door 10.

In accordance with the embodiment shown in the figures, the movable leaf 7 is of the rigid type and the movement means 8 comprise tilting movement members.

The main door 10 is, therefore, of the type of an overhead door.

It cannot, however, be ruled out that the main door 10 may be of a different type, e.g., a sectional door or a sliding door.

According to the invention, at least one of the fixed uprights 2, the fixed crossbeam 3 or the movable uprights 5 is made according to respective predefined standard dimensions which are bigger than the reference dimensions and comprises at least one related trimmable portion 9 provided with a graduated reference scale 11 adapted to allow the trimmable portion itself to be cut depending on the reference dimensions.

In actual facts, the kit 1 can be made at the factory prior to taking the measurements of the access opening and can be adapted to the latter during installation.

Thus, the kit 1 allows for a significant reduction in production and delivery timelines and ensures proper installation of the main door 10.

Specifically, the panels 6 are also made according to respective predefined standard dimensions which are bigger than the reference dimensions.

In accordance with the preferred embodiment, the panels 6 are finished according to the actual dimensions of the movable leaf.

It cannot, however, be ruled out that the panels 6 may also be provided with relevant trimmable portions 9 provided with a graduated reference scale 11 adapted to allow the cut thereof according to reference dimensions.

Advantageously, the graduated reference scale 11 comprises a set of reference values corresponding to one of either a set of values of height or a set of values of width.

In detail, depending on the type of component to which it is applied, the graduated reference scale 11 may have reference values corresponding to the height or width of the access opening.

In accordance with the embodiment shown in the figures, the graduated reference scale 11 is of the type of an adhesive label.

It cannot, however, be ruled out that the graduated reference scale 11 is engraved on the trimmable portion 9 or made in some other way.

The trimmable portion 9 comprises at least one cut reference 12 at each reference value.

The function of the cut reference 12 is to facilitate the cutting operation and to ensure that it is performed correctly.

Specifically, the cut reference 12 is of the type of an incision, bevel, groove or the like, made on the trimmable portion 9.

In addition, the trimmable portion 9 comprises a plurality of drills 13 defined at the reference values and adapted to allow the assembly of the various components following the cutting operation.

The fixed crossbeam 3 comprises two ending stretches 14, each defining a relevant trimmable portion 9.

In detail, the trimmable portions 9 of the fixed crossbeam 3 have reference values corresponding to the width of the access opening.

The fixed crossbeam 3 is, therefore, trimmable at both ends.

The presence of the two trimmable portions 9 allows the length of the fixed crossbeam 3 to be adjusted by removing a portion of equal length from both ending stretches 14.

By doing so, any components associated with the fixed crossbeam 3 are centered with respect to the length of the crossbeam itself.

For example, with reference to the embodiment shown in the figures, the movement means 8 comprise a motor assembly 15 mounted in a central stretch of the fixed crossbeam 3.

The presence of two trimmable portions 9 allows keeping the motor assembly 15 in a central position of the fixed crossbeam 3, thus ensuring proper operation of the same.

Each fixed upright 2 comprises an upper stretch 16 and a lower stretch 17, opposite the upper stretch 16 and defining a relevant trimmable portion 9.

It should be clarified that in this disclosure, the expressions “lower” and “upper” refer to the position of the relevant component once it is assembled and installed at the compartment access opening and with the main door 10 in the closing configuration.

The trimmable portion 9 of the fixed upright 2 has reference values corresponding to the height of the compartment access opening.

In accordance with the embodiment shown in the figures, the movement means 8 comprise a pulley assembly 18, mounted at the top of the fixed upright 2, that is, at the end of the upper stretch 16.

Conveniently, the trimmable portion 9 defined on the lower stretch 17 allows the adjustment of the length of the fixed upright 2 by avoiding the previous removal of the pulley assembly 18.

Similarly, each of the movable uprights 5 comprises an upper end 19 and a lower end 20, opposite the upper end 19.

Specifically, the upper end 19 is intended, in the closure configuration, to operate in conjunction with the upper stretch 16 of the fixed upright 2, while the lower end 20 is intended to operate in conjunction with the lower stretch 17 of the fixed upright 2.

The upper end 19 defines a relevant trimmable portion 9.

The trimmable portion 9 of the movable upright 5 also has reference values corresponding to the height of the access opening.

The kit 1, in accordance with the embodiment shown in the figures, comprises tilting movement means 8.

In detail, the movement means 8 comprise:
at least two lateral supporting arms 21, each having a first end 22 which can be hinged at one intermediate area 23 of a respective movable upright 5 and a second end 24 which can be hinged at a top of a respective fixed upright 2; and
at least two sliding supports 25, each one fixable to a respective movable upright 5 and associable by sliding with a respective fixed upright 2.

In more detail, the first end 22 is hinged to a small block 26, which can be attached to a respective movable upright 5.

The second end 24 is coupled to a hinging pin 27, arranged at the top of a respective fixed upright 2.

The function of the lateral supporting arms 21 is to guide the movement of the movable leaf 7 at the upper end 19 of the movable upright 5 and to support the weight thereof.

The lateral supporting arms 21 must, therefore, be correctly sized and positioned so as to allow for the proper movement of the movable leaf 7. Advantageously, each of the lateral supporting arms 21 comprises at least one relevant trimmable portion 9, provided with the graduated reference scale 11 and defined at the first end 22.

In particular, the lateral supporting arm 21 may be trimmed at the hinging portion to the movable upright 5.

In fact, it is worth specifying that, generally, at the second end 24, the lateral supporting arm 21 may have a curved pattern and/or shaping.

The trimmable portion 9 of the lateral supporting arm 21 also has reference values corresponding to the height of the access opening.

Once trimmed, the lateral supporting arm 21 is attached to the movable upright 5 by means of the small block 26 at a predefined position according to the value of height.

For this purpose, the movable upright 5 comprises a first graduated positioning scale 28, defined at the intermediate area 23 and adapted to allow the first end 22 to be positioned depending on the value of height.

The function of the sliding supports 25 is to guide the movement of the movable leaf 7 at the lower end 20 of the movable upright 5.

For this purpose, the fixed uprights 2 are provided with vertical sliding rails 29, within which the sliding supports 25 can be moved.

The sliding supports 25 consist, e.g., of needle rollers which roll inside the vertical sliding rails 29.

Each of the sliding supports 25 is attached to a respective movable upright 5 at a point comprised between the base of the movable upright 5 and the aforementioned intermediate area 23 for hinging the lateral supporting arms 21. To couple the sliding supports 25 to the vertical sliding rails 29, each of the latter comprises at least a discharge portion, i.e., an interruption adapted to allow the sliding supports 25 to be fitted within them.

Once fitted into the vertical sliding rail 29, the sliding support 25 is attached to the movable upright 5 in a predefined position according to the value of height. For this purpose, the movable upright 5 comprises a second graduated positioning scale 30, defined at the lower end 20 and adapted to allow the sliding support 25 to be positioned depending on the value of height.

Each of the above graduated positioning scales 28, 30 comprises a relevant set of reference values corresponding to the set of values of height.

In addition, at the graduated positioning scales 28, 30, the movable upright comprises a plurality of drills 13, adapted to facilitate the proper attachment of the lateral supporting arm 21 and of the sliding support 25 as a result of the positioning thereof.

To facilitate the movement of the movable leaf 7 between the closure configuration and the opening configuration, the movement means 8 comprise a pulley assembly 18 mounted at the top of each fixed upright 2.

The pulley assembly 18 also supports the hinging pin 27, to which the lateral supporting arms 21 are hinged.

Each pulley assembly 18 is provided with at least one pulley 31 on which a rope 32 connected to a respective movable upright 5 and to at least one counterweight is at least partly wound.

The function of the counterweight is to facilitate the movement of the movable leaf 7 during the opening and closure of the main door 10.

In detail, the movement means 8 comprise at least one rope assembly 33, comprising a rope 32 provided with one end associated with a rope support 34 attachable with a respective movable upright 5, and an opposite end associable with a respective counterweight.

In the context of the present invention, the term “rope” means any flexible element that, when wound on the pulleys 31, can perform the function of a proper rope, so also a ribbon, chain or the like.

Conveniently, the rope support 34 is attachable to the movable upright 5 at a predefined distance D from the sliding support 25.

The setting in rotation of the pulleys 31 and the movement of the relevant counterweights is preferably achieved by the fact that the movement means 8 also comprise the motor assembly 15.

The motor assembly 15 comprises a motor 35, adapted to set a drive shaft in rotation, not shown in detail in the figures.

The drive shaft extends from the motor 35 at the ends of the fixed crossbeam 3 up to the pulley assemblies 18.

Finally, the kit 1 comprises the panels 6 associable with the movable uprights 5 to define the movable leaf 7.

Each of the panels 6 is substantially rectangular in shape and has two long sides, opposite each other, and two short sides, opposite each other.

Each of the panels 6 comprises at least one of a connection portion 36 and a housing portion 37, complementary to each other, adapted to allow the association of each panel 6 with at least one adjacent panel 6.

Specifically, the connection portion 36 and the housing portion 37 are defined on at least one of the long sides of the panels 6.

The panels 6 can be attached to the movable uprights 5 once the latter have been assembled to their respective fixed uprights 2.

According to a further aspect, the present invention also relates to a method for the assembly of a main door for the closure of a compartment, particularly of a garage compartment.

The method first comprises a phase of carrying a kit 1 according to one or more of the embodiments described above, at one access opening of a compartment.

At this point, the method comprises measuring the access opening and detecting the value of width and the value of height.

Next, the method comprises a phase of cutting the fixed crossbeam 3 at the at least one trimmable portion 9 depending on the value of width.

In more detail, the phase of cutting of the fixed crossbeam 3 comprises cutting both trimmable portions 9 by a portion of the same length.

Next, the method comprises a phase of cutting the fixed uprights 2 and the movable uprights 5 at the relevant trimmable portions 9 depending on the value of height.

The fixed uprights 2 and the fixed crossbeam 3 are, then, assembled to each other to obtain the fixed frame 4, which is then attached to the access opening. The assembly of the fixed frame 4 and its attachment to the access opening is carried out by means of fasteners of known type.

At this point, the method comprises a phase of installing the movement means 8 between the fixed uprights 2 and the movable uprights 5.

Finally, the method comprises a phase of applying the panels 6 to the movable uprights 5 to obtain the movable leaf 7.

In accordance with the embodiment of the kit 1 shown in the figures, the method also comprises at least one phase of cutting the lateral supporting arm 21 at the relevant trimmable portion 9, depending on the value of height.

Advantageously, each of the cutting phases comprises:
at least one step of identifying a relevant reference value on the graduated reference scale 11, corresponding to one of either the value of height or the value of width; and
at least one step of cutting the trimmable portion 9, at the relevant reference value.

The step of cutting is carried out at the corresponding cut reference 12.

In addition, the method comprises at least one phase of positioning the first end 22 on the movable upright 5.

The phase of positioning of the first end 22 comprises:
at least one step of identifying a relevant reference value on the first graduated positioning scale 28, corresponding to the value of height; and
at least one step of hinging the first end 22, at the relevant reference value.

Specifically, the small block 26 is made to slide until the reference value is reached and then attached to the movable upright 5.

In addition, the method comprises at least one phase of positioning the sliding support 25 on the movable upright 5.

The phase of positioning the sliding support 25 comprises:
at least one step of identifying a relevant reference value on the second graduated positioning scale 30, corresponding to the value of height; and
at least one step of fixing the sliding support 25, at the relevant reference value.

In detail, first the sliding support 25 is fitted into the vertical sliding rail 29 through the unloading portion, then it is made to slide along the same until the reference value is reached and, then, attached to the movable upright 5.

Next, the method comprises the attachment of the rope assembly 33 to the movable upright 5, at a predetermined distance from the sliding support 25, and the connection of the rope 32 to the counterweight, by means of the pulley assembly 18.

Finally, the panels 6 are trimmed according to the actual dimensions of the movable leaf 7 and assembled to the movable uprights 5.

It has in practice been ascertained that the described invention achieves the intended objects and, in particular, the fact is emphasized that the present kit for the assembly of a main door for the closure of a compartment, makes it possible to free oneself from the need for on-site measurements prior to the production of the same.

Thanks to the trimmable portion and to the graduated reference scale, the various components can be prepared on site and adapted to the actual size of the access opening.

In addition, the kit according to the present invention allows for quick yet accurate assembly and installation operations on site.

In fact, this kit allows the measurement of the access opening of the compartment and installation to be carried out at the same time.

In addition, the kit can be produced and stored according to standard predefined dimensions.

Finally, this kit makes it possible to ensure proper operation of the movement members of the movable leaf at all times.

In fact, the positioning of the various movement members is also adjustable depending on the actual size.

1) A kit for an assembly of a main door for a closure of an opening of a compartment, or of a garage compartment, the kit comprising:
at least two fixed uprights and at least one fixed crossbeam, said fixed uprights being associable with said fixed crossbeam to define a fixed frame that can be attached to an access opening of a compartment, wherein said access opening has relevant reference dimensions;
at least two movable uprights and a plurality of panels, associable with said movable uprights to define a movable leaf;
movement means, associable between said movable uprights and said fixed frame and adapted to determine a movement of said movable leaf with respect to said fixed frame;
where said fixed uprights, said fixed crossbeam, said movable uprights, said panels and said movement means can be assembled together to form a main door;
at least one of said fixed uprights, said fixed crossbeam and said movable uprights is made according to respective predefined standard dimensions, which are bigger than said reference dimensions, and comprises at least one related trimmable portion, provided with at least one graduated reference scale adapted to allow a cutting of said trimmable portion depending on said reference dimensions.

2) The kit according to claim 1, wherein said reference dimensions comprise at least one value of height and one value of width, said graduated reference scale comprising a set of reference values corresponding to one of a set of values of height and a set of values of width.

3) The kit according to claim 1, wherein said fixed crossbeam comprises two ending stretches, each defining a relevant trimmable portion.

4) The kit according to claim 1, wherein each of said fixed uprights comprises an upper stretch and a lower stretch, opposite said upper stretch and defining a relevant trimmable portion.

5) The kit according to claim 1, wherein each of said movable uprights comprises an upper end and a lower end, opposite said upper end, wherein said upper end defines a relevant trimmable portion.

6) The kit according to claim 2, wherein said movement means comprise:
at least two lateral supporting arms, each having a first end which can be hinged at one intermediate area; of a respective movable upright, and a second end which can be hinged at a top of a respective fixed upright; and
at least two sliding supports, each one fixable to a respective movable upright and associable by sliding with a respective fixed upright;
wherein each of said lateral supporting arms comprises at least one relevant trimmable portion, provided with said graduated reference scale and defined at said first end.

7) The kit according to claim 6, wherein said movable upright comprises a first graduated positioning scale, defined at said intermediate area and adapted to allow said first end to be positioned depending on said value of height.

8) The kit according to claim 7, wherein said movable upright comprises at least a second graduated positioning scale, defined at said lower end and adapted to allow said sliding support to be positioned depending on said value of height.

9) The kit according to claim 8, wherein each of said graduated positioning scales comprises a relevant set of reference values corresponding to said set of values of height.

10) The kit according to claim 1, wherein said movement means comprise at least one rope assembly, comprising a rope, provided with one end associated with a rope support attachable to a respective movable upright, and an opposite end associable with a respective counterweight, said rope support; being attachable to said movable upright at a predefined distance from said sliding support.

11) A method for the assembly of a main door for the closure of an opening of a compartment, or of a garage compartment, said method comprising:
carrying the kit according to claim 1 to one access opening of a compartment;
measuring said access opening and detecting said value of width and said value of height;
cutting said fixed crossbeam at the at least one trimmable portion, depending on said value of width;
cutting said fixed uprights and said movable uprights at the relevant trimmable portions, depending on said value of height;
assembling said fixed uprights to said fixed crossbeam to obtain said fixed frame;
fixing said fixed frame to said access opening;
installing said movement means between said fixed uprights and said movable uprights; and
applying said panels to said movable uprights to obtain said movable leaf.

12) The method according to claim 11, said method further comprises at least one phase of cutting said lateral supporting arm at the relevant trimmable portion, depending on said value of height.

13) The method according to claim 12, wherein each of said cutting phases comprises:
at least one step of identifying a relevant reference value on said graduated reference scale, corresponding to one of said value of height and said value of width; and
at least one step of cutting said trimmable portion, at said relevant reference value.

14) The method according to claim 13, said method further comprises at least one phase of positioning said first end on said movable upright comprising:
at least one step of identifying a relevant reference value on said first graduated positioning scale, corresponding to said value of height; and
at least one step of hinging said first end, at said relevant reference value.

15) The method according to claim 13, said method further comprises at least one phase of positioning said sliding support on said movable upright comprising:
at least one step of identifying a relevant reference value on said second graduated positioning scale, corresponding to said value of height; and
at least one step of fixing said sliding support, at said relevant reference value.
